(19) United States
(12) Patent Application Publication
(10) Pub. No.: US 2008/0274854 A1
(43) Pub. Date: Nov. 6, 2008

(54) Trike reverse gear

(76) Inventor: Beryl Paffrath, Burns, WY (US)

Correspondence Address: David E. Orr, 4616 NE 134th Street, Vancouver, WA, 98686, US

(21) Appl. No.: 11/799,599

(22) Filed: May 3, 2007

(51) Int. Cl. F16H 3/22

(52) U.S. Cl. 475/336

(57) ABSTRACT

In an exemplary embodiment a mechanism for providing a gear mechanism having neutral, forward and reverse gear states for a Trike. The operation of the reverse gear mechanism is determined by its structure of conical gears affixed to shafts. The change of gear state is dependent upon causing, by a shifting device, engagement of certain conical gears resulting in certain rotational directions of shafts within the mechanism. In forward gear operation, as shown in FIG. 2, gear 2330 rotating in a counter-clockwise direction engages gear 2340, which is coupled to shaft 2430. Gear 2330 rotating counter-clockwise engages gear 2340 causing it to rotate counter-clockwise, which in turn causes shaft 2430 to rotate counter-clockwise or, by convention, in a forward direction. In reverse gear operation, as shown in FIG. 3, gear 3330 rotating in a counter-clockwise direction engages gear 3320, which is coupled to shaft 3410. Gear 3330 rotating counter-clockwise engages gear 3320 causing it to rotate clockwise, which in turn causes shaft 3410 to rotate clockwise. Gear 3310 engages gear 3370, causing gear 3370 to rotate counter-clockwise. Shaft 3440 is coupled to gear 3370, and is also coupled to gear 3360. Therefore gear 3360 also rotates counter-clockwise. Gear 3360 engages gear 3350, and causes gear 3350 to rotate clockwise. Shaft 3430 is coupled to gear 3350, and therefore also rotates clockwise, or, by convention, in reverse direction. For neutral gear operation, gear F330 does not engage any other gear, therefore output power shaft F430 does not rotate.

### FIELD

The present invention relates to gears and transmissions for vehicles; more specifically the present invention is a reverse gear for a tri-wheel motorcycle (trike).

### BACKGROUND

A Trike is a three-wheeled motorcycle. Riders convert motorcycles to a Trike for a variety of reasons, including rider and co-rider comfort and more stability. Other riders have physical limitations and a Trike allows them to still enjoy the experience of riding a motorcycle.

Since a Trike a three-wheeled vehicle and therefore free of the balancing issues in a two-wheeled motorcycle, learning to ride a Trike is easier than a traditional motorcycle. And with today's modern designs, suspension systems, braking systems, etc. the handling is significantly improved over earlier models. Brute strength is no longer a requirement for riding a motorcycle. Many women prefer Trikes because they need not worry about supporting a heavy motorcycle.

Unlike a two-wheeled motorcycle which requires at least one foot on the ground to balance the bike, a Trike has three wheels and the rider's feet never touch the ground. The rider is always balanced, whether stopped or moving.

While a trike is much easier to handle and ride, there are still some improvements to be made to trikes. Despite the ease of riding and handling a Trike, what is needed is a reverse gear mechanism.

### SUMMARY

According to the need and desirability of a reverse gear mechanism for a Trike, herein is disclosed in an exemplary embodiment a mechanism for providing a gear mechanism having neutral, forward and reverse gear states. The operation of the reverse gear mechanism is determined by its structure of conical gears affixed to shafts. The change of gear state is dependent upon causing, by a shifting device, engagement of certain conical gears resulting in certain rotational directions of shafts within the mechanism.

As shown in the attached drawings, power is provided to the shaft designated as F420, which has affixed thereto gear F330, which will be designated F330. A direction of rotation of F420 has been assigned, which is counter-clockwise, designated as CCW. Therefore the state of gear F330 is designated as CCW, or in a symbolic form [F330, CCW].

### Summary of Forward Gear Operation

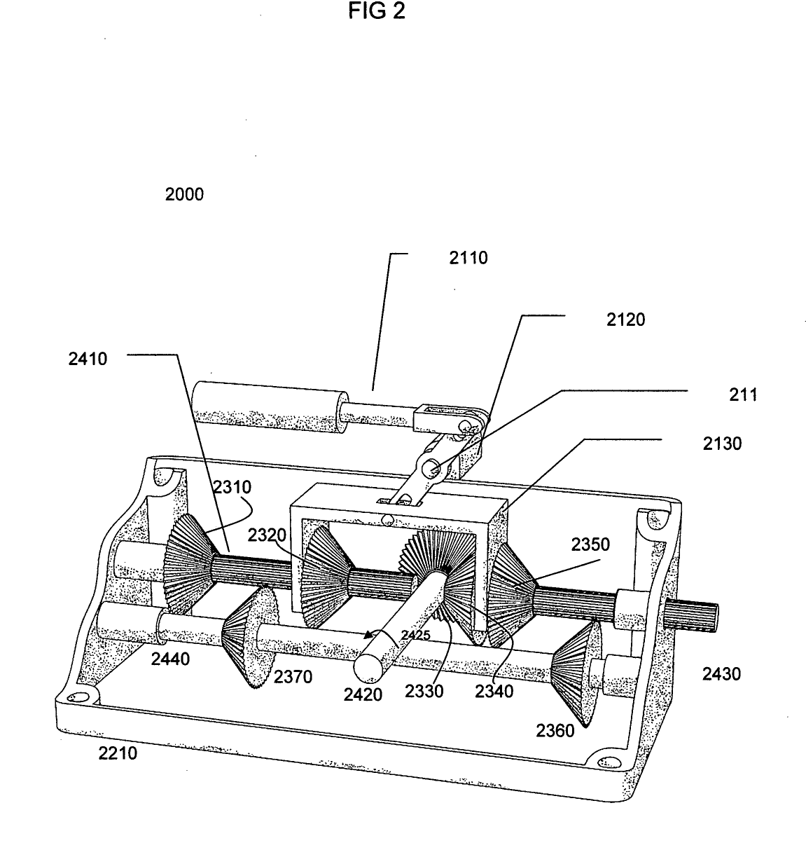

In forward gear operation, as shown in FIG. 2, gear 2330 rotating in a counter-clockwise direction—CCW—engages gear 2340, which is coupled to shaft 2430. Gear 2330 rotating CCW engages gear 2340 causing it to rotate CCW, which in turn causes shaft 2430 to rotate CCW or, by a chosen convention, in a forward direction.

### Summary of Reverse Operation

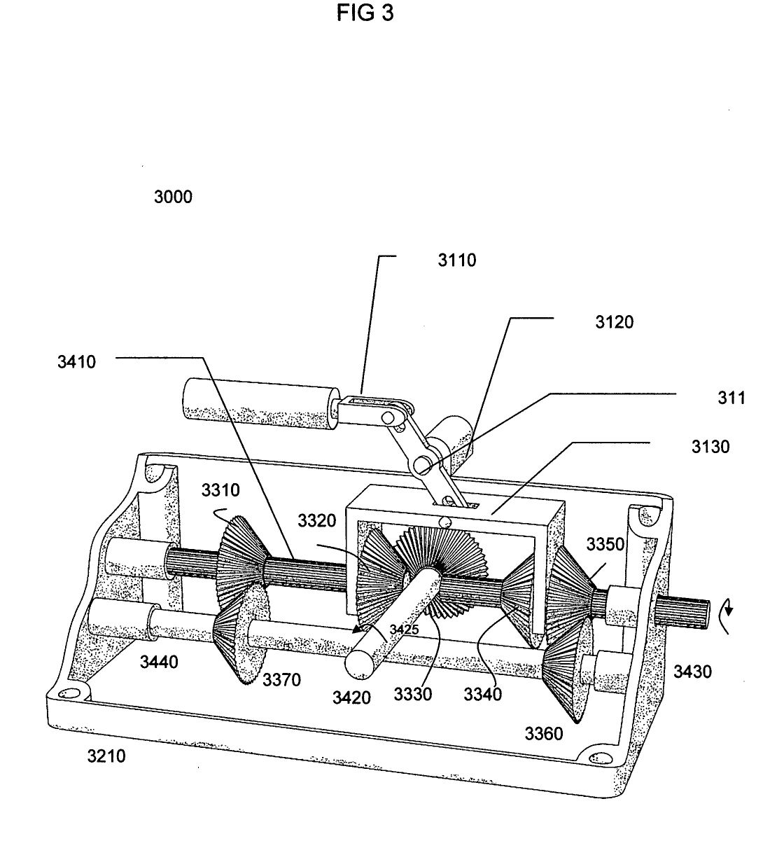

In reverse gear operation, as shown in FIG. 3, gear 3330 rotating in a counter-clockwise direction—CCW—engages gear 3320, which is coupled to shaft 3410. Gear 3330 rotating CCW engages gear 3320 causing it to rotate CW (clockwise), which in turn causes shaft 3410 to rotate CW. Gear 3310 engages gear 3370, causing gear 3370 to rotate CCW. (counter clockwise) Shaft 3440 is coupled to gear 3370, and is also coupled to gear 3360. Therefore gear 3360 also rotates CCW. Gear 3360 engages gear 3350, and causes gear 3350 to rotate CW. Shaft 3430 is coupled to gear 3350, and therefore also rotates CW, or, by convention, in reverse direction.

### Summary of Neutral Gear Operation

Gear F330 does not engage any other gear, therefore output power shaft F430 does not rotate.

### OBJECTS AND ADVANTAGES

A first object and advantage of the present invention is a reverse gear that facilitates backing a Trike out of places that are to small to turn around.

A second object and advantage is a reverse gear mechanism that may be installed or retrofitted on all Trikes.

Another object and advantage is a novel reverse gear mechanism that is robust and reliable.

Additional objects, benefits and advantages of the invention will appear from the disclosure to follow. In the disclosure reference is made to the accompanying drawings, which form a part hereof and in which is shown by way of illustration a specific embodiment in which the invention may be practiced. This embodiment will be described in sufficient detail to enable those skilled in the art to practice the invention, and it is to be understood that other embodiments may be utilized and that structural changes may be made in details of the embodiments without departing from the scope of the invention.

### BRIEF DESCRIPTION OF DRAWINGS

### Labeling Conventions Used

In the drawings, a four digit number will be assigned to each element in the drawing. The label will be of the form FENN, where:

F is the number of the figure. E is the number of the element of the exemplary embodiment. NN is the feature or component of the element. Therefore 1ENN refers to element E and component NN in the first figure.

In the labeling convention, F000 is assigned to the exemplary embodiment as shown if figure F.

The following codes will be assigned to elements of the exemplary embodiment:
1NN refers to a component of the shifting device
2NN designates the frame for holding and restraining other elements
3NN refers to conical gear NN
4NN designates shaft NN

### DESCRIPTION OF THE FIGURES

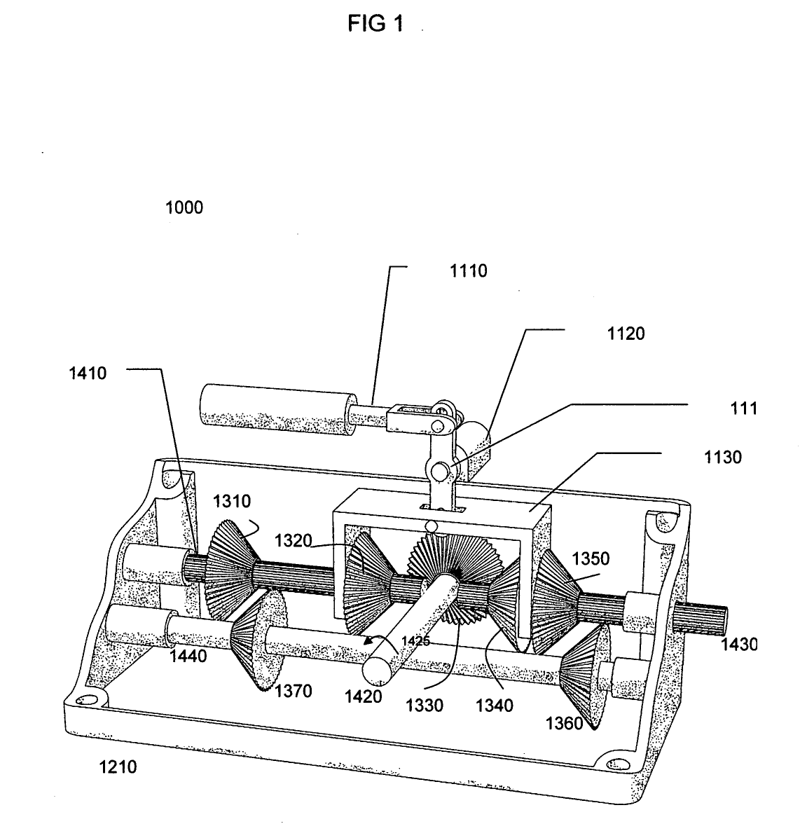

FIG. 1 shows an exemplary embodiment of the reverse gear mechanism, with the mechanism in neutral.

FIG. 2 shows the configuration of gear engagements resulting in a forward direction of a Trike using the exemplary embodiment.

FIG. 3 shows the configuration of gear engagements resulting in a reverse direction of a Trike using the exemplary embodiment.

### DETAILED DESCRIPTION

With respect to FIG. 1, FIG. 2 and FIG. 3, the following conical gears are shown: F310, and F320 are shown affixed to shaft F410. Conical gear F330 is affixed to shaft F420. Conical gears F340 and F350 are affixed to shaft F430. Conical gears F360 and F370 are affixed to shaft F440.

Also with reference to FIG. 1, FIG. 2, and FIG. 3, shafts F410 and F430 are made so that the conical gears, which are affixed thereto, may slide or move along the length of the referenced shafts.

With reference to FIG. 1, FIG. 2 and FIG. 3, power from an engine is transmitted to the shaft F420, which has attached and fixed conical gear F350. A rotational direction is assumed given by the arrow labeled F425.

By action of the shifting device F110 and the shifting fork F130, power from an engine is either not transmitted or is transmitted by conical gears to cause either clockwise or counter clockwise rotation of shaft F430, which is assumed to cause power to be given to wheels of the Trike.

A convention has been chosen for direction; the convention is the engine delivers power to shaft F420 and conical gear F330, causing rotation in a counter-clockwise (CC) direction. By the gear arrangement of the reverse gear transmits power to shaft F430. It is assumed that a counter-clockwise rotation of shaft F340 corresponds to forward and a clockwise rotation of shaft F340 corresponds to reverse. It will be appreciated that the directions chosen may be reversed or exchanged.

Again, with reference to FIG. 1, FIG. 2 and FIG. 3, a shifting device FINN is shown. In each drawing, a handle is shown for purposes of illustration of the exemplary embodiment. It will be appreciated that the handle may be replaced by cables, or other forms of linkage and means for transmitting forces to the shifting device. In the FIGS, the exemplary embodiment shows a handle that is made to operate a shifting fork F130, which changes the configuration of conical gears and shafts to cause the gear box of the mechanism to change state from neutral to forward to reverse and so forth.

With reference to FIG. 1, FIG. 2, and FIG. 3, the shifting device is operated to cause the shifting fork F130 to move conical gears F320, F340 and F350 along a line parallel to the shaft F430 and the shaft F410, which are concentric. The line passes through the centers of the shafts F430 and F410.

When the shifting device F110 is moved to the right as shown in FIG. 2, conical gear F330 engages conical gear F340. When the shifting device is moved in the left, as shown in FIG. 3, conical gear F330 engages conical gear F320.

### An Exemplary Embodiment

In the exemplary embodiment, FIG. 1 shows the mechanism in neutral gear; FIG. 2 shows the mechanism in forward gear and FIG. 3 shows the mechanism operating in operating in reverse gear.

In FIG. 1, FIG. 2 and FIG. 3, power from an engine is transmitted by rotation of the shaft F420 and conical gear F330.

In FIG. 1, FIG. 2 and FIG. 3, the direction of movement of a Trike wherein the mechanism has been installed is determined by operation of the shifting device, which causes either no rotation, clockwise rotation or counter-clockwise rotation of shaft F430. In the exemplary embodiment, it is assumed that shaft F430 is coupled to the driving wheels of the Trike, which is not shown in FIG. 1, FIG. 2, and FIG. 3.

The shifting device F110 engages the shifting fork F130 and causes the shifting fork F130 to move along the line passing through the centers of shaft F410 and shaft F430. Movement of the shifting fork F130 causes conical gears F310, F320, F340 and F350 to move along the said line passing through the centers of shafts F410 and F430.

By action and movement of the shifting device F110, F120, F125 and F130, conical gear F330 affixed to shaft F420 is caused to operate in one of the following states: (1) conical gear F330 does not engage either conical gear F320 or F340; (2) conical gear F330 engages conical gear F340, and (3) conical gear F330 engages conical gear F320.

Each shifting state corresponds respectively to (1) neutral; (2) forward or (3) reverse.

Neutral gear is exemplified by shaft F430 not rotating. Forward gear operation results in shaft F430 rotating in a counter-clockwise direction, and revere gear operation results in shaft F430 rotating in a clockwise direction.

### Neutral Operation

FIG. 1 depicts neutral gear operation, wherein, by action of the shifting device 1110 and the shifting fork 1130, conical gear 1330 does not engage any other conical gear, thereby causing shaft 1430 not to rotate.

### Forward Gear Operation

FIG. 2 depicts forward gear operation. In FIG. 2, by action of the shifting fork 2110, conical gear 2330 is made to engage conical gear 2340. As conical gear 2330 rotates in a counter-clockwise direction, so does conical gear 2340. Since conical gear 2340 is coupled to shaft 2430, then shaft 2340 also rotates in a counter-clockwise direction, and by assumption corresponds to a forward direction.

### Reverse Gear Operation

FIG. 3 depicts reverse gear operation, wherein conical gear 3330 (rotating in a counter-clockwise direction) engages conical gear 3320, causing conical gear 3320, and by shaft coupling of shaft 3410, conical gear 3310, to rotate in a clockwise direction. Conical gear 3370 is engaged by conical gear 3310, and is made to rotate in a counter-clockwise direction. Through shaft 3440, conical gear 3360 is made to rotate in a counter-clockwise direction. Conical gear 3350 is engaged by conical gear 3360, and is made to rotate in a clockwise direction. By coupling to conical gear 3350, shaft 3430 is also made to rotate in a clockwise (or by the assumptions given above) a reverse direction.

### DISCLOSURE SUMMARY

A reverse gear mechanism for a Trike has been disclosed. It will be appreciated that variants of the disclosure may be devised, wherein the variants utilize the inventive concepts and novel design of this disclosure. Therefore, the true scope and breadth of this invention is defined by the accompanying claims.

I claim:

1. A reverse gear mechanism for a trike, with reference to FIG. 2, comprises a shifting fork 2110, conical gears 2310, 2320, 2330, 2340, 2350, 2370, 2360, further comprises shafts 2410, 2330, 2430, 2440, wherein gear 2310 engages shaft 2410, gear 2320 engages shaft 2410, gear 2330 engages shaft 2420, gear 2340 engages shaft 2430, gear 2350 engages shaft 2430, gear 2370 engages shaft 2440, gear 2360 engages shaft 2440, wherein forward gear comprises by action of the shifting fork 2110, conical gear 2330 is made to engage conical gear 2340, and as gear 2330 rotates in a counter-clockwise direction, so does conical gear 2340, whereby conical gear 2340 coupled to shaft 2430, causes shaft 2340 to rotates in a counter-clockwise direction corresponding to a forward direction.
